(19) United States
(12) Patent Application Publication
(10) Pub. No.: US 2025/0162061 A1
(43) Pub. Date: May 22, 2025

(54) Method for connecting nickel ferrite-based ceramic inert anode and metal conductive block

(71) Applicant: ZHENGZHOU NON-FERROUS METALS RESEARCH INSTITUTE CO.LTD OF CHALCO, Zhengzhou (CN)

(72) Inventors: Dongsheng LI, Zhengzhou (CN); Guanghui HOU, Zhengzhou (CN); Shengzhong BAO, Zhengzhou (CN); Junyi MA, Zhengzhou (CN); Dan LIU, Zhengzhou (CN); Huiyao WANG, Zhengzhou (CN)

(73) Assignee: ZHENGZHOU NON-FERROUS METALS RESEARCH INSTITUTE CO.LTD OF CHALCO, Zhengzhou (CN)

(21) Appl. No.: 19/022,691

(22) Filed: Jan. 15, 2025

Related U.S. Application Data
(63) Continuation of application No. PCT/CN2024/082743, filed on Mar. 20, 2024.

(30) Foreign Application Priority Data
Mar. 24, 2023 (CN) 202310298466.3

(51) Int. Cl. B23K 20/02; B23K 20/14; C25B 11/047

(52) U.S. Cl. CPC B23K 20/02; B23K 20/14; C25B 11/047

(57) ABSTRACT

A method for connecting a nickel ferrite-based ceramic inert anode and a metal conductive block, including: providing a nickel ferrite-based ceramic inert anode and a metal conductive block, and processing surfaces of the nickel ferrite-based ceramic inert anode and the metal conductive block to form surfaces to be connected; providing a transition alloy foil, and attaching the surfaces to be connected of the nickel ferrite-based ceramic inert anode and the metal conductive block respectively to two surfaces of the transition alloy foil to form a prefabricated connection body; performing a vacuum diffusion welding on the prefabricated connection body.

### CROSS-REFERENCE TO RELATED APPLICATIONS

This is a continuation of International Patent Application No. PCT/CN2024/082743 filed on Mar. 20, 2024, which claims priority to Chinese patent application No. 202310298466.3 filed on Mar. 24, 2023. The disclosures of the above-referenced applications are hereby incorporated by reference in their entirety.

### BACKGROUND

The existing Hall-Herout aluminum electrolytic cell uses consumable carbon anodes, such that a large amount of high-quality carbon materials are consumed and a large amount of greenhouse gas such as CO₂ and carcinogenic fluorocarbons are discharged. Continuous replenishment for anode paste or replacement for carbon blocks of anodes are required during an aluminum electrolysis, resulting in unstable electrolysis production and increased labor intensity.

Inert anodes and corresponding electrolytic processes have become a focus of attention and research hotpot in the international aluminum industry and material industry, as the inert anodes and corresponding electrolytic processes can solve the above-mentioned problems and reduce a production cost of aluminum ingots by nearly 30%. A use of inert anodes in the process of aluminum electrolysis has following advantages: (1) electrodes are hardly consumed during the electrolysis, and no additional carbon processing plant is required, thereby reducing production costs; (2) the electrodes are not consumed, an inter-electrode distance being stable and easy to be controlled, the number of replacements for an anode being less, a labor intensity being reduced; (3) a higher current density of anode may be used to increase a production capacity of the electrolytic cell; (4) a product from anode is oxygen, thereby avoiding environmental pollution; the oxygen can also be used as a by-product, and it is estimated that a value of recovered oxygen may be 3% of a value of original aluminum product. This series of advantages of inert anodes make a development of suitable inert anodes an important portion for improving traditional methods for aluminum production. The inert anodes need to have the following properties: a corrosion resistance to electrolytes in an environment for aluminum electrolysis, i.e., low solubility in the electrolytes; resistance to oxygen filtration; good electrical conductivity (a resistivity of the inert anode≤a resistivity of a carbon anode); high mechanical strength, strong thermal shock resistance, and non-brittle; excellent property in manufacturing, and easy connection to metal conductors; and easily obtained and inexpensive raw materials. According to current research, ceramic alloy materials have the excellent conductivity and processability of metal materials and the good resistance to molten salt corrosion of ceramic materials, and thus the ceramic alloy materials are brought about the most promising materials for the inert anode to replace carbon anodes.

The inert anode needs to be supplied with electric current by a metal conductive block to work. However, there are great differences in physical and chemical properties between the ceramic alloy materials and the metal conductive block. Therefore, there are the following difficulties in welding of the ceramic alloy materials and the metal conductive block: (1) different crystal structures of the ceramic alloy materials and the metal conductive block lead to different melting points; (2) a strong bond energy of ceramic crystal makes it extremely difficult for components to diffuse; (3) thermal expansion coefficients of the ceramic alloy materials and the metal conductive block differ greatly, resulting in a great thermal stress in joints and easy cracking on a side of the ceramic alloy materials; (4) brittle portions are generated between surfaces to be connected, such that a performance of ceramic is weakened. Therefore, it is difficult to achieve a connection between the ceramic alloy materials and the metal conductive block by using conventional welding methods.

### SUMMARY

The technical problem of difficulty in connecting an inert anode to a metal conductive block is solved by utilizing one or more embodiments of the disclosure.

The disclosure relates to a field of aluminum electrolysis, and in particular to an aluminum electrolytic cell.

The embodiment of the disclosure provides a method for connecting a nickel ferrite-based ceramic inert anode and a metal conductive block. The method for connecting a nickel ferrite-based ceramic inert anode and a metal conductive block includes the following steps: providing a nickel ferrite-based ceramic inert anode and a metal conductive block, and processing surfaces of the nickel ferrite-based ceramic inert anode and the metal conductive block to form surfaces to be connected; providing a transition alloy foil, and attaching the surfaces to be connected of the nickel ferrite-based ceramic inert anode and the metal conductive block respectively to two surfaces of the transition alloy foil to form a prefabricated connection body; and performing a vacuum diffusion welding on the prefabricated connection body.

### BRIEF DESCRIPTION OF DRAWINGS

The accompanying drawings, which are incorporated in and constitute a portion of this specification, illustrate embodiments consistent with the disclosure and, together with this specification, serve to explain principles of the disclosure.

In order to more clearly illustrate the technical solutions in the embodiments of the disclosure or related technologies, the following will be a brief introduction to accompanying drawings required in the description of the embodiments or related technologies are briefly introduced below. Obviously, for those of ordinary skill in the art, other accompanying drawings can be obtained based on these accompanying drawings without creative effort.

FIG. 1 is a schematic structural diagram of a prefabricated connection body according to Example 1 of the disclosure;

FIG. 2 is a schematic structural diagram of a prefabricated connection body according to Example 2 of the disclosure; and

FIG. 3 is a schematic structural diagram of a prefabricated connection body according to Example 3 of the disclosure.

### DETAILED DESCRIPTION

In order to make the purposes, technical solutions and advantages of the embodiments of the disclosure clearer, the technical solutions in the embodiments of the disclosure will be clearly and completely described below in conjunction with the accompanying drawings in the embodiments of the disclosure. Obviously, the described embodiments are only a portion of embodiments of the disclosure, not all the embodiments. Based on the embodiments in the disclosure, all other embodiments obtained by those skilled in the art without any creative efforts fall within the scope of protection sought by the disclosure.

Unless otherwise specifically stated, the terms used herein should be understood as having the same meanings as commonly used in the art. Therefore, unless defined otherwise, all technical and scientific terms used herein have the same meaning as commonly understood by those skilled in the art to which this disclosure belongs. In case of conflict, the description in this specification shall prevail.

Unless otherwise specified, various raw materials, reagents, instruments and apparatuses used in the disclosure can be purchased from the market or prepared by existing methods.

At present, there is a technical problem in the field of aluminum electrolysis that it is difficult to connect an inert anode with a metal conductive block.

The technical solution provided by the embodiments of the disclosure is to solve the above technical problems, and the overall idea is as follows.

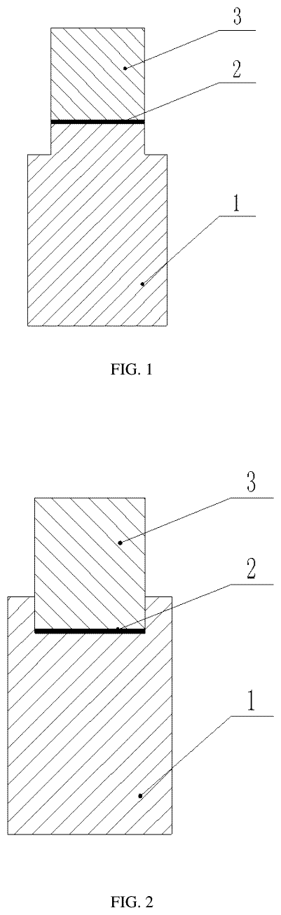

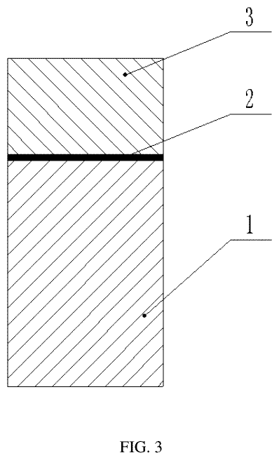

The embodiment of the disclosure provides a method for connecting a nickel ferrite-based ceramic inert anode and a metal conductive block. As shown in FIGS. 1 to 3, the method for connecting a nickel ferrite-based ceramic inert anode 1 and a metal conductive block 3 includes the following steps:
S1: providing a nickel ferrite-based ceramic inert anode 1 and a metal conductive block 3, and processing surfaces of the nickel ferrite-based ceramic inert anode 1 and the metal conductive block 3 to form surfaces to be connected;
S2: providing a transition alloy foil 2, and attaching the surfaces to be connected of the nickel ferrite-based ceramic inert anode 1 and the metal conductive block 2 respectively to two surfaces of the transition alloy foil 2 to form a prefabricated connection body; and,
S3: performing a vacuum diffusion welding on the prefabricated connection body.

Those skilled in the art will appreciate that the vacuum diffusion welding may be performed through a vacuum diffusion furnace. A melting point of the transition alloy foil 2 is lower than melting points of the metal conductive block 3 and the nickel ferrite-based ceramic inert anode 1, which is a general condition for implementation of the vacuum diffusion welding. The transition alloy foil 2 with a lower melting point is selected as an interlayer. The interlayer, when heated to a melting point thereof, melts and forms an instantaneous liquid film between the surfaces to be connected. During a process of thermal insulation, as components of the interlayer which has low-melting point diffuse to the metal conductive block 3 and the nickel ferrite-based ceramic inert anode 1, the liquid film decreases in thickness until disappears. After a certain period of thermal insulation, compositions near the surfaces to be connected are homogenized. With a formation of the liquid film, and a diffusion of the components of the liquid film, the transition alloy foil 2 is fixed between the surfaces to be connected.

Since the components with lower melting point in the liquid film diffuse into the metal conductive block 3 and the nickel ferrite-based ceramic inert anode 1 in large quantities, some components in the metal conductive block 3 and the nickel ferrite-based ceramic inert anode 1 are dissolved by the liquid film, causing a melting point of the liquid film to gradually increase and thus the liquid film gradually solidify. A solidification interface advances from two sides of the liquid film to a middle of the liquid film. As the thermal insulation proceeds, the liquid film between the surfaces to be connected gradually decreases and finally a joint is formed.

A concentration gradient between the liquid film and the surfaces to be connected can be increased by disposing the transition alloy foil 2, to promote a diffusion of the components and accelerate a disappearance of diffusion cavities. The transition alloy foil 2 can relieve a residual stress caused by different thermal expansion coefficients of ceramics and metals, control a reaction at the solidification interface, inhibit or change reaction products of the reaction at the solidification interface, and improve a quality of the joint. The transition alloy foil 2 may be a combination of an adhesive alloy material and a reactive alloy material. The transition alloy foil 2 with suitable compositions may reduce the temperature, time, and pressure of the vacuum diffusion welding and improve a performance of joint. The adhesive alloy material, which does not react with a ceramic material but can diffuse with a ceramic component, is selected to form a diffusion layer. The reactive alloy material can interact with a ceramic to form a reaction product, and the ceramic and the metal are firmly connected through the reaction product.

In the disclosure the transition alloy foil 2 is used as a welding medium and a method of vacuum diffusion welding is adopted to connect the nickel ferrite-based ceramic inert anode 1 and the metal conductive block 3 through a diffusion of the instantaneous liquid film. Under operating conditions of the vacuum diffusion welding, the transition alloy foil 2 forms the instantaneous liquid film between surfaces to be connected. As the components of the liquid film diffuse into the nickel ferrite-based ceramic inert anode 1 and the metal conductive block 3, and the components of the nickel ferrite-based ceramic inert anode 1 and the metal conductive block 3 diffuse into the liquid film, the liquid film decreases in thickness and disappears, and finally a metallurgical grade bond is formed. The joint for connection formed by this way for bonding is homogeneous and dense, without cavities and cracks, and has a connection strength that is≥150 MPa.

In addition, in the disclosure a connection speed is fast and a connection efficiency is high. A diffusion connection between the nickel ferrite-based ceramic inert anode 1 and the metal conductive block 3 can be completed in only 20 minutes. A connection accuracy is high and a deformation of material is small. A method for connecting in the disclosure can be suitable for a connection of the nickel ferrite-based ceramic inert anode 1 with various shapes and structures, and can also be used for a connection of the nickel ferrite-based ceramic inert anode 1 with a large-sized planar structure, that is, a method for connecting in the disclosure has a wide range of applicability. Operations of method for connecting in the disclosure are simple. An obtained joint for connection has high strength, strong corrosion resistance, and good conductivity. The obtained joint, under conditions of aluminum electrolysis, will not crack or fall off after long-term use.

In some embodiments, an arithmetic average deviation of surface profile of the surfaces to be connected is 0.6×10⁻⁴ cm˜2.5×10⁻⁴ cm.

A surface roughness can have a significant impact on diffusion welding. A low surface roughness can make parts to be bonded with one another more tightly under an action of temperature and pressure, and achieve a more sufficient diffusion and a more reliable quality of welding.

In some embodiments, the processing surfaces of the nickel ferrite-based ceramic inert anode and the metal conductive block to form surfaces to be connected includes:
Step S11: cleaning the surfaces of the nickel ferrite-based ceramic inert anode 1 and the metal conductive block 3; and
Step S12: polishing cleaned surfaces with 120 #, 220 #, 500 #, 1000 #, 1500 #, 2000 #, and 2500 #sandpapers in sequence.

A purpose of polishing the cleaned surfaces with sandpapers is to control the arithmetic average deviation of surface profile of the surfaces to be connected to be 0.6×10⁻⁴ cm˜2.5×10⁻⁴ cm.

In some embodiments, materials of the transition alloy foil 2 includes Fe—Ni alloy.

In some embodiments, the materials of the transition alloy foil 2 further include at least one of B, Si, V and Co.

In some embodiments, the transition alloy foil 2 includes, by mass percentage thereof:
B 0.01%˜2%,
Si 0.05˜5%,
V 0.01%˜2%,
Co 0.1˜5%,
the rest is Fe—Ni alloy.

In some embodiments, a thickness of the transition alloy foil 2 ranges from 5 μm-500 μm.

In some embodiments, the vacuum diffusion welding has:
a diffusion temperature of 950° C.-1200° C.; and/or,
a heating rate of 10° C./min-30° C./min; and/or,
a time of thermal insulation of 2 min-20 min; and/or,
a pressure of 5 MPa-30 MPa; and/or,
a cooling rate of 4° C./min-8° C./min.

The higher a temperature is, the greater a diffusion coefficient is, and the faster a diffusion speed is, such that the smaller a pressure is, the pressure being required for the surfaces to be connected to achieve a close contact. However, a too high temperature may easily cause the metal conductive block 3 to melt or soften, and thus it not only affects compositions and surface states of materials, but also affects a phase change of the interlayer. Therefore, the diffusion temperature is selected to be 0.6 Tm˜0.8 Tm, and is generally between 950° C.-1200° C. Tm is a melting point of the metal conductive block.

The greater the pressure applied is, the larger the close contact area of the surfaces to be connected is, and thus it is conducive to obtaining a contact surface with good performance. At the same time, cavities generated at a connection interface by the ceramic material of the nickel ferrite-based ceramic inert anode 1 can be effectively filled to prevent the diffusion cavities from being generated. However, an excessive pressure will cause a macroscopic plastic deformation of the metal conductive block 3, and thus a pressure for diffusion is 5 Mpa-30 MPa.

A depth of the diffusion layer is proportional to a square root of a diffusion time. Strength, plasticity, elongation and impact toughness of the joint increase to a certain extent and then tend to be stable. Excessive long high temperature and high pressure will not have any effect on further improving a quality of the joint.

After the joint is formed through the vacuum diffusion welding via the instantaneous liquid film, a faster cooling rate will cause a large internal stress in the joint because of a large difference in thermal expansion coefficients between the ceramic material of the nickel ferrite-based ceramic inert anode 1 and a metal material of the metal conductive block 3, and in turn resulting in an initiation of microcracks. Therefore, the cooling rate should be controlled after the thermal insulation is completed. When the joint is cooled at a cooling rate of 4° C./min-8° C./min, the internal stress in the joint can be effectively reduced, and thus it is advantageous to ensure a performance of the joint.

A specific operation method of the vacuum diffusion welding is a conventional technical means in this field. In some embodiments, the specific operation method of the vacuum diffusion welding is as follows.

A prefabricated connection body consisting of a NiFe₂O₄-based ceramic inert anode, a transition alloy foil 2, and a metal conductive block 3 is placed in a vacuum diffusion furnace. A mechanical pump and a Roots pump are turned on respectively to effectively remove an air in the vacuum diffusion furnace. When a vacuum degree within the vacuum diffusion furnace reaches 10⁻³ Pa, a high-purity argon or high-purity nitrogen is filled into the vacuum diffusion furnace to make a pressure in the vacuum diffusion furnace reach 0.1 Pa˜0.9 Pa. The vacuum diffusion furnace is heated with a heating rate of 10° C./min-30° C./min to a temperature of 950° C.-1200° C. therein and a pressure of 5 MPa-30 MPa is applied to the vacuum diffusion furnace with the high-purity argon or high-purity nitrogen. Under the above conditions, the vacuum diffusion furnace is then thermally insulated for 2 min-20 min, and then the temperature in the vacuum diffusion furnace is cooled to 400° C. with a rate of 4° C./min-8° C./min, and then is cooled to a room temperature.

In some embodiments, the nickel ferrite-based ceramic inert anode 1 is one of a NiFe₂O₄—X ceramic inert anode or NiFe₂O₄—X—Y metal ceramic inert anode which is formed by sintering.

In some embodiments, in the NiFe₂O—X ceramic inert anode or NiFe₂O₄—X—Y ceramic inert anode, X is a composite ceramic phase including at least one of ZnO, CuO, Cr₂O₃, MgO, Y₂O₃ and TiN.

Y is a composite metal phase including at least one of Cu, Ni, Fe, Co, Cr, Al, Mn and rare earth.

X is a composite ceramic phase which can improve a sintering performance or densification performance of the inert anode.

Y is a composite metal phase which can improve a corrosion resistance of the inert anode.

The disclosure is further described below in conjunction with specific embodiments. It should be understood that these examples are only used to illustrate the disclosure and are not intended to limit the scope of the disclosure. Experimental methods without specifying specific conditions in the following examples are typically performed in accordance with Chinese national standards. If there is no corresponding Chinese national standards, general international standards, conventional conditions, or conditions recommended by the manufacturer shall be followed.

### Example 1

Prepared powders of NiO, Fe₂O₃, ZnO, Cu and Fe are pressed as a ceramic inert anode green body via a way of isostatic pressing at 130 Mpa, and then the ceramic inert anode green body is sintered at 1000° C. in a nitrogen atmosphere to form a nickel ferrite-based ceramic inert anode 1, an oxygen content in the nitrogen atmosphere being controlled to be no higher than 200 ppm. Then a metal conductive block 3 is precisely machined by mechanical processing, such that a size of the metal conductive block 3 meets requirements for connection.

Foreign matters adhering to the surfaces to be connected are blown out with a compressed air, and then the surfaces to be connected are polished with 120 #, 220 #, 500 #,1000 #, 1500 #, 2000 #, and 2500 #sandpapers in sequence and are repeatedly cleaned with alcohol to ensure that the surfaces to be connected of the nickel ferrite-based ceramic inert anode 1 and the metal conductive block 3 are clean and tidy. The arithmetic average deviation of surface profile of the surfaces to be connected is 1.5×10⁻⁴ cm.

Referring to FIG. 1, a size of an end of the nickel ferrite-based ceramic inert anode 1 is smaller than another end of the nickel ferrite-based ceramic inert anode 1. A contour of an end of a processed metal conductive block 3 is completely consistent with a contour of an end of the nickel ferrite-based ceramic inert anode 1. A transition alloy foil 2 is attached to the surfaces to be connected of the NiFe₂O₄-based ceramic inert anode 1 and the metal conductive block 3 to form a prefabricated connection body. Compositions of the transition alloy foil 2 by mass percentage includes Ni 30%, Cr 6%, B 1%, Si 1%, Co 0.5%, V 0.5%, the rest being Fe. The transition alloy foil 2 has a thickness of 20 μm. The prefabricated connection body consisting of a NiFe₂O₆-based ceramic inert anode, a transition alloy foil 2, and a metal conductive block 3 is placed in a vacuum diffusion furnace. A mechanical pump and a Roots pump are turned on respectively to effectively remove an air in the vacuum diffusion furnace. When a vacuum degree within the vacuum diffusion furnace reaches 10⁻³ Pa, a high-purity argon or high-purity nitrogen is filled into the vacuum diffusion furnace to make a pressure in the vacuum diffusion furnace reach 0.3 pa. The vacuum diffusion furnace is heated with a heating rate of 12° C./min to a temperature of 1020° C. therein, and a pressure of 6 MPa is applied to the vacuum diffusion furnace with the high-purity argon or high-purity nitrogen. Under the above conditions, the vacuum diffusion furnace is then thermally insulated for 5 min, and then the temperature in the vacuum diffusion furnace is cooled to 400° C. with a rate of 6° C./min, and then is cooled to a room temperature. The nickel ferrite-based ceramic inert anode 1 formed by sintering and the metal conductive block 3 of a certain length are reassembled by thread connection or welding to complete a connection of the inert anode as a whole. This inert anode can operate stably for a long time under conditions of electrolysis temperature of 800° C. and current density of 10 A/cm².

### Example 2

Prepared powders of NiO, Fe₂O₃, MgO, Cu, Fe and Ni are pressed as a ceramic inert anode green body via a way of isostatic pressing at 130 MPa, and then the ceramic inert anode green body is sintered at 1000° C. in a nitrogen atmosphere to form a nickel ferrite-based ceramic inert anode 1, an oxygen content in the nitrogen atmosphere being controlled to be no higher than 200 ppm. Then a metal conductive block 3 is precisely machined by mechanical processing, such that a size of the metal conductive block 3 meets requirements for connection. Foreign matters adhering to the surfaces to be connected are blown out with a compressed air, and then the surfaces to be connected are polished with 120 #, 220 #, 500 #, 1000 #, 1500 #, 2000 #, and 2500 #sandpapers in sequence and are repeatedly cleaned with alcohol to ensure that the surfaces to be connected of the nickel ferrite-based ceramic inert anode 1 and the metal conductive block 3 are clean and tidy. The arithmetic average deviation of surface profile of the surfaces to be connected is 1.2×10⁻⁴ cm.

Referring to FIG. 2, an end of the nickel ferrite-based ceramic inert anode 1 has a groove, and a contour of an end of a processed metal conductive block 3 is completely consistent with a contour of the groove. A transition alloy foil 2 is attached to the surfaces to be connected of the NiFe₂O₄-based ceramic inert anode 1 and the metal conductive block 3 to form a prefabricated connection body. Compositions of the transition alloy foil 2 by mass percentage includes Ni 26%, Cr 8%, B 1.2%, Si 1.5%, Co 1.0%, V 0.8%, the rest being Fe. The transition alloy foil 2 has a thickness of 30 μm. The prefabricated connection body consisting of a NiFe₂O₆-based ceramic inert anode, a transition alloy foil 2, and a metal conductive block 3 is placed in a vacuum diffusion furnace. A mechanical pump and a Roots pump are turned on respectively to effectively remove an air in the vacuum diffusion furnace. When a vacuum degree within the vacuum diffusion furnace reaches 10⁻³ Pa, a high-purity argon or a high-purity nitrogen is filled into the vacuum diffusion furnace to make a pressure in the vacuum diffusion furnace reach 0.3 pa. The vacuum diffusion furnace is heated with a heating rate of 10° C./min to a temperature of 1050° C. therein, and a pressure of 8 MPa is applied to the vacuum diffusion furnace with the high-purity argon or high-purity nitrogen. Under the above conditions, the vacuum diffusion furnace is then thermally insulated for 10 min, and then the temperature in the vacuum diffusion furnace is cooled to 400° C. with a rate of 6° C./min, and then is cooled to a room temperature. The nickel ferrite-based ceramic inert anode 1 formed by sintering and the metal conductive block 3 of a certain length are reassembled by thread connection or welding to complete a connection of the inert anode as a whole. This inert anode can operate stably for a long time under conditions of electrolysis temperature of 850° C. and current density of 10 A/cm².

### Example 3

Prepared powders of NiO, Fe₂O₃, Y₂O₃, Fe, Ni and Co are pressed as a ceramic inert anode green body via a way of isostatic pressing at 130 MPa, and then the ceramic inert anode green body is sintered at 1000° C. in a nitrogen atmosphere to form a nickel ferrite-based ceramic inert anode 1, an oxygen content in the nitrogen atmosphere being controlled to be no higher than 200 ppm. Then a metal conductive block 3 is precisely machined by mechanical processing, such that a size of the metal conductive block 3 meets requirements for connection. Foreign matters adhering to the surfaces to be connected are blown out with a compressed air, and then the surfaces to be connected are polished with 120 #, 220 #, 500 #, 1000 #, 1500 #, 2000 #, and 2500 #sandpapers in sequence and are repeatedly cleaned with alcohol to ensure that the surfaces to be connected of the nickel ferrite-based ceramic inert anode 1 and the metal conductive block 3 are clean and tidy. The arithmetic average deviation of surface profile of the surfaces to be connected is 1.8×10⁻⁴ cm.

Referring to FIG. 1, a size of an end of the nickel ferrite-based ceramic inert anode 1 is equal to another end of the nickel ferrite-based ceramic inert anode 1. A contour of an end of a processed metal conductive block 3 is completely consistent with a contour of an end of the nickel ferrite-based ceramic inert anode 1. A transition alloy foil 2 is attached to the surfaces to be connected of the NiFe₂O₄-based ceramic inert anode and the metal conductive block 3 to form a prefabricated connection body. Compositions of the transition alloy foil 2 by mass percentage includes Ni 20%, Cr 10%, B 1.5%, Si 2%, Co 0.5%, V 0.5%, the rest being Fe. The transition alloy foil 2 has a thickness of 50 μm. The prefabricated connection body consisting of a NiFe₂O₆-based ceramic inert anode, a transition alloy foil 2, and a metal conductive block 3 is placed in a vacuum diffusion furnace. A mechanical pump and a Roots pump are turned on respectively to effectively remove an air in the vacuum diffusion furnace. When a vacuum degree within the vacuum diffusion furnace reaches 10⁻³ Pa, a high-purity argon or a high-purity nitrogen is filled into the vacuum diffusion furnace to make a pressure in the vacuum diffusion furnace reach 0.5 pa. The vacuum diffusion furnace is heated with a heating rate of 12° C./min to a temperature of 1100° C. therein, and a pressure of 10 MPa is applied to the vacuum diffusion furnace with the high-purity argon or high-purity nitrogen. Under the above conditions, the vacuum diffusion furnace is then thermally insulated for 15 min, and then the temperature in the vacuum diffusion furnace is cooled to 400° C. with a rate of 6° C./min, and then is cooled to a room temperature. The nickel ferrite-based ceramic inert anode 1 formed by sintering and the metal conductive block 3 of a certain length are reassembled by thread connection or welding to complete a connection of the inert anode as a whole. This inert anode can operate stably for a long time under conditions of electrolysis temperature of 800° C. and current density of 10 A/cm².

Various embodiments of the disclosure may exist in the form of a range; it should be understood that the description in the form of a range is only for convenience and simplicity and should not be understood as a hard limit to the scope of the disclosure. Therefore, the described range should be considered to have specifically disclosed all possible subranges as well as the single values within such a range. For example, a description of a range from 1 to 6 should be considered to have specifically disclosed subranges, such as from 1 to 3, from 1 to 4, from 1 to 5, from 2 to 4, from 2 to 6, and from 3 to 6, and a single number within the stated range, such as 1, 2, 3, 4, 5, and 6, which applies regardless of the range. Additionally, whenever a numerical range is indicated herein, it is intended to include any cited number (fractional or whole) within the indicated range.

In the disclosure, unless otherwise specified, directional words such as “upper” and “lower” used refer specifically to the directions of drawings in the accompanying drawings. Additionally, in the description in specification of the disclosure, the terms “include”, “contain” and the like mean “including but not limited to”. Moreover, the terms “include”, “contain” or any other variations thereof are intended to cover non-exclusive inclusion, such that a process, method, article, or apparatus that includes a list of elements includes not only those elements but also other elements not expressly listed, or also includes elements inherent to such process, method, article, or apparatus. Without more constraints, the elements defined by the phrase “including . . . ” do not exclude the existence of other identical elements in the process, method, article or apparatus including the elements. In this disclosure, relational terms such as “first” and “second” are used merely to distinguish one entity or operation from another entity or operation, but do not necessarily require or imply any actual relationship or order between these entities or operations. In the disclosure, “and/or” describes the relationship between associated objects, indicating that there may be three relationships. For example, A and/or B may refer to: A alone, both A and B, and B alone. For the association relationship of more than three associated objects described by “and/or”, it indicates that any one of the three associated objects may exist alone, or at least two of the three associated objects may exist at the same time. For example, for A, and/or B, and/or C, it may indicate that any one of A, B, and C exists alone, or any two of A, B, and C exist at the same time, or three of A, B, and C exist at the same time. In this document, “at least one” means one or more, and “plurality” means two or more. “At least one”, “at least one of the following” or similar expressions thereof refers to any combination of these items, including single items or any combination of plural items. For example, “at least one of a, b, or c”, or “at least one of a, b, and c” can mean: a, b, c, a˜b (that is, a and b), a˜c, b˜c, or a˜b-c, where a, b, and c can each be single or multiple.

The above descriptions are only specific embodiments of the disclosure, enabling those skilled in the art to understand or implement the disclosure. Various modifications to these embodiments will be readily apparent to those skilled in the art, and the generic principle defined herein may be practiced in other embodiments without departing from the spirit or scope of the disclosure. Therefore, the disclosure is not to be limited to the embodiments shown herein but is to be accorded the widest scope consistent with the principles and novel features claimed herein.

What is claimed is:

1. A method for connecting a nickel ferrite-based ceramic inert anode and a metal conductive block, comprising:
providing a nickel ferrite-based ceramic inert anode and a metal conductive block, and processing surfaces of the nickel ferrite-based ceramic inert anode and the metal conductive block to form surfaces to be connected;
providing a transition alloy foil, and attaching the surfaces to be connected of the nickel ferrite-based ceramic inert anode and the metal conductive block respectively to two surfaces of the transition alloy foil to form a prefabricated connection body; and
performing a vacuum diffusion welding on the prefabricated connection body;
wherein the transition alloy foil comprises, by mass percentage thereof:
B: 0.01% ˜2%,
Si: 0.05˜5%,
V: 0.01% ˜2%,
Co: 0.1% ˜5%,
Ni: 20% ˜30%,
the rest being Fe;
wherein, the vacuum diffusion welding is performed at a diffusion temperature of 950° C.-1200° C., a heating rate of 10° C./min-30° C./min, a time of thermal insulation of 2 min-20 min, a pressure of 5 Mpa-30 MPa, and a cooling rate of 4° C.-8° C./min.

2. The method of claim 1, wherein an arithmetic average deviation of surface profile of the surfaces to be connected ranges from 0.6×10⁻⁴ cm to 2.5×10⁻⁴ cm.

3. The method of claim 2, wherein the processing the surfaces of the nickel ferrite-based ceramic inert anode and the metal conductive block to form the surfaces to be connected, comprises:
cleaning the surfaces of the nickel ferrite-based ceramic inert anode and the metal conductive block; and
polishing cleaned surfaces using 120 #, 220 #, 500 #, 1000 #, 1500 #, 2000 #, and 2500 # sandpapers in sequence.

4. The method of claim 1, wherein a thickness of the transition alloy foil ranges from 5 μm-500 μm.

5. The method of claim 1, wherein the nickel ferrite-based ceramic inert anode 1 is one of a NiFe₂O₄—X ceramic inert anode or NiFe₂O₄—X—Y metal ceramic inert anode which is formed by sintering.

6. The method of claim 5, wherein in the NiFe₂O₄—X ceramic inert anode or the NiFe₂O₄—X—Y metal ceramic inert anode,
X is a composite ceramic phase comprising at least one of ZnO, CuO, Cr₂O₃, MgO, Y₂O₃ and TiN, and
Y is a composite metal phase comprising at least one of Cu, Ni, Fe, Co, Cr, Al, Mn and rare earth.
